(19) United States
(12) Patent Application Publication
(10) Pub. No.: US 2019/0201948 A1
(43) Pub. Date: Jul. 4, 2019

(54) METHOD AND APPARATUS FOR CLEANING A GLASS SUBSTRATE

(71) Applicant: CORNING INCORPORATED, CORNING, NY (US)

(72) Inventors: Hsueh-Hung Fu, Hsinchu (TW); Jun-Yuan Hou, Tainan City South District (TW); Tzu-Hen Hsu, Taichung City (TW); Xiaofeng Mu, Shanghai (CN); William Paul Ryszytiwskyj, Conesus, NY (US); Naiyue Zhou, Painted Post, NY (US)

(21) Appl. No.: 16/326,821

(22) PCT Filed: Aug. 24, 2017
(86) PCT No.: PCT/US17/48298

§ 371 Date: Feb. 20, 2019

Related U.S. Application Data
(60) Provisional application No. 62/379,315, filed on Aug. 25, 2016.

(51) Int. Cl. B08B 11/04; B08B 5/02; B08B 5/04

(52) U.S. Cl. CPC B08B 11/04; C03B 17/064; B08B 5/043; B08B 5/023

(57) ABSTRACT

An apparatus and method for cleaning a glass substrate is disclosed, the apparatus including a shroud assembly arranged along a conveyance path of a glass substrate such that an opening of shroud portion of the shroud assembly is adjacent the glass substrate. A nozzle assembly contained within a hollow interior space of the shroud assembly rotates while directing a jet of gas at the glass substrate, dislodging particulate. A vacuum is applied to a second interior hollow space defined by a skirt portion extending around the shroud, thereby removing the dislodged particulate. A second vacuum is applied to a back portion of the shroud to remove particulate accumulated in the shroud. The apparatus may further include a gas knife arranged adjacent the shroud assembly and a vacuum channel arranged below the shroud assembly.

### CROSS-REFERENCE TO RELATED APPLICATIONS

The application claims the benefit of priority of U.S. Provisional Application Ser. No. 62/379,315 filed on Aug. 25, 2016 the contents of which are relied upon and incorporated herein by reference in their entirety as if fully set forth below.

### BACKGROUND

### Field

The present invention relates generally to methods and apparatus for cleaning a substrate, for example a planar glass substrate, and more particularly to removing particulate matter and other debris from a surface of a substrate as the substrate is conveyed.

### Technical Background

Generation of particles (hereinafter, “particulate”) in a manufacturing process may be inevitable. In many industries, this may not present a problem. However, in certain other industries, for example in the manufacture of glass display panels from planar glass substrates, particulate deposited on the glass substrates can lead to the production of inoperative display panels. Due to the brittle nature of glass, generation of glass particulate is difficult to avoid, particularly during processes involving the cutting of glass, for example the cutting of individual glass sheets from a longer glass ribbon. If glass particulate is not removed shortly after being deposited on surfaces of the glass sheets, the glass particulate can become strongly adhered to the surfaces, rendering the glass particulate virtually impossible to completely remove. Accordingly, such removal efforts should be deployed as close to particulate-generating processes, and initial contamination of the glass, as practical. Additionally, particulate removal processes should dislodge the particulate from the surfaces of the glass sheet, remove the particulate from the vicinity of the glass sheet surfaces and prevent the particulate from being re-deposited on those surfaces.

### SUMMARY

The present disclosure describes apparatus and methods for removing particulate from surfaces of a substrate, and in particular glass substrates. Embodiments herein describe a glass cleaning apparatus comprising one or more shroud assemblies positioned such that as glass substrates are conveyed past the shroud assemblies, a revolving gas jet positioned within a shroud dislodges particulate on the surface of the glass substrate adjacent the shroud. The revolving characteristic of the gas jet ensures the particulate is attacked from all angles by the gas jet, thereby increasing the ability of the gas jet to dislodge the particulate. Additionally, a skirt portion positioned about the end of the shroud closest to the glass substrate forms an annular space between the skirt portion and the shroud to which a vacuum is applied. Described herein as a ring vacuum, the ring vacuum applied within the annular space collects the dislodged particulate and evacuates it through an exhaust port in fluid communication with the annular space. Gas knives positioned about the shroud assemblies direct a curtain of gas, for example air, in the gap between the shroud assembly and the surface of the glass substrate, thereby forcing particulate that may have escaped the ring vacuum back between the shroud assembly and the glass substrate so that the particulate can be captured by the ring vacuum. A vacuum port provided at the rear of the shroud can be used to clear the shroud of particulate that may have accumulated within the shroud. Described herein as a center vacuum, the center vacuum applied from the rear of the shroud is preferably applied between glass substrates. That is, as sequential glass substrates are conveyed past the shroud assembly, the center vacuum is turned off prior to a glass substrate being presented adjacent to the shroud assembly, then turned back on after the glass substrate has passed the shroud assembly. Operation of the center vacuum simultaneous with the ring vacuum and the gas jet while a glass substrate is directly adjacent a glass substrate has been found to disrupt the flow of gas (e.g., air) within the shroud, which is detrimental to the ability of the shroud assembly to dislodge and exhaust particulate from the glass substrate surface. A vacuum channel positioned below the shroud assembly can be used to collect large size particulate that falls without being exhausted by the ring vacuum.

Accordingly, an apparatus for cleaning a planar substrate is disclosed comprising a shroud assembly comprising a shroud defining a first hollow interior space, the shroud further including a first end defining a first opening into the interior space and a second end opposite the first end and defining a second opening into the interior space. The apparatus further comprises a nozzle member mounted within the interior space and rotatable about an axis of rotation, the nozzle member comprising a first vent arranged to direct a first flow of gas toward the substrate. The nozzle member may also include a second vent arranged to direct a second flow of gas in a direction orthogonal to the axis of rotation, thereby applying a thrust that rotates the gas nozzle about an axis of rotation. The shroud assembly may include a skirt portion positioned about at least a portion of the shroud adjacent the first opening such that an annular second hollow interior space is formed between the skirt portion and the shroud. The shroud assembly may also comprise a first vacuum port in fluid communication with the first interior space through the second opening and a second vacuum port in fluid communication with the annular second hollow interior space. The shroud may comprise at least one conical portion.

In some embodiments, the first vent may be arranged to direct the first flow of gas inward, in a direction toward the axis of rotation.

The apparatus may further comprise at least one gas knife positioned proximate the shroud assembly and arranged to direct a third flow of gas in a direction toward the substrate.

In some embodiments, the apparatus may further comprise a vacuum channel positioned below the shroud assembly and configured to collect large particulate that falls from the vicinity of the shroud assembly.

The apparatus according may further comprise a conveyance apparatus configured to convey the substrate in a substantially vertical orientation such that the first opening is positioned adjacent a major surface of the substrate as the substrate is conveyed past the shroud assembly.

In some embodiments, the glass cleaning apparatus can comprise a pair of opposing shroud assemblies positioned such that the planar substrate is conveyed between the pair of opposing shroud assemblies, the pair of shroud assemblies simultaneously cleaning at least a portion of both major surfaces of the substrate.

In some embodiments, a projection of the second opening on the first opening is concentric with the first opening. That is, a longitudinal axis of the shroud, which is coincident with the axis of rotation of the nozzle member, passes through the center of both the first and second openings.

In some embodiments, a least a portion of the shroud is cylindrical.

The conveyance apparatus may comprises a conveyance member, a carriage assembly coupled to the conveyance member and movable along a length thereof in a conveyance direction and a pair of extension devices coupled to the carriage assembly, each extension device of the pair of extension devices including a guide arm extending therefrom in a direction substantially parallel with the conveyance direction, the guide arms movable along a lateral direction orthogonal to the conveyance direction. The conveyance apparatus may further comprise a first sensor, for example an optical sensor, positioned to detect a leading edge of the glass sheet at a first position and a controller configured to control and coordinate movement of the carriage assembly and the pair of extension devices. Each guide arm can comprise a plurality of rollers arrayed along a length of the guide arm. In some embodiments, each guide arm can comprise a plurality of gas ports in fluid communication with a source of pressurized gas. The apparatus may further comprise a second sensor positioned to detect a leading edge of the glass sheet at a second position downstream of the first position relative to the conveyance direction. In some embodiments, the apparatus may include a third sensor positioned to detect the leading edge of the glass sheet at a third position, the third sensor vertically aligned with the first sensor. For example, the third sensor may be positioned to detect the leading edge of the glass sheet at a bottom edge portion of the glass sheet.

In another embodiment, a method of cleaning a glass substrate is disclosed comprising conveying the glass substrate in a conveyance direction, the glass substrate passing adjacent a glass cleaning apparatus comprising a shroud assembly, the shroud assembly including: a shroud defining a first hollow interior space, the shroud comprising a first end defining a first opening into the first hollow interior space and a second end opposite the first end, the second end defining a second opening into the first hollow interior space, and wherein a diameter of the second opening is less than a diameter of the first opening. The shroud assembly may further include a nozzle member mounted within the interior space and rotatable about an axis of rotation, the nozzle member comprising a first vent arranged to direct a first flow of gas in a direction toward a major surface of the glass substrate. The shroud assembly may still further include a skirt portion positioned about at least a portion of the shroud adjacent the first opening such that an annular second hollow interior space is formed between the skirt portion and the shroud. The shroud assembly may yet further include a first vacuum port in fluid communication with the annular second hollow interior space, the method further comprising rotating the nozzle member about the axis of rotation such that the first flow of gas sweeps a circular path over a surface of the glass substrate through the first opening and dislodges particulate from the surface of the glass substrate and applying a suction to the first vacuum port, thereby exhausting the dislodged particulate through the second vacuum port.

The shroud may include a second vacuum port in fluid communication with the first hollow interior space through the second opening, the method further comprising applying a suction to the second vacuum port only when the glass substrate is not adjacent the shroud assembly.

In some embodiments, rotating the nozzle member can comprise directing a second flow of gas through a second vent in the gas nozzle member configured to direct the second flow of gas in a direction orthogonal to the axis of rotation, thereby rotating the nozzle member.

In some embodiments, a projection of the second opening onto the first opening is concentric with the first opening.

In some embodiments, the shroud comprises at least one conical portion.

In some embodiments, the glass substrate may be conveyed while supported from a top thereof in a substantially vertical orientation, wherein the conveying comprises sensing a position of a leading edge of the glass substrate relative to the conveyance direction and using the sensed position of the leading edge to determine a conveyance speed. The method may further comprise moving a carriage assembly in the conveyance direction at the conveyance speed in response to the sensed position of the glass sheet, the carriage assembly comprising a pair of opposing guide arms coupled thereto and extending therefrom in a direction substantially parallel with the conveyance direction. The method may still further comprise moving the guide arms in a lateral direction orthogonal to the conveyance direction from an open position to a constraining position, thereby reducing a gap between the guide arms and constraining movement of the glass substrate in a direction orthogonal to the conveyance direction.

Additional features and advantages of the embodiments disclosed herein will be set forth in the detailed description that follows, and in part will be readily apparent to those skilled in the art from that description or recognized by practicing the invention as described herein, including the detailed description that follows, the claims, as well as the appended drawings.

It is to be understood that both the foregoing general description and the following detailed description present embodiments intended to provide an overview or framework for understanding the nature and character of the claimed invention. The accompanying drawings are included to provide further understanding, and are incorporated into and constitute a part of this specification. The drawings illustrate various embodiments of the disclosure, and together with the description serve to explain the principles and operations thereof.

### BRIEF DESCRIPTION OF THE DRAWINGS

FIG. 1 is a schematic view of an exemplary glass making apparatus;

FIG. 2 is a perspective view of a glass substrate processing station that may be used with the glass making apparatus of FIG. 1;

FIG. 3 is a top view of a portion of a conveyance apparatus of the glass substrate processing station of FIG. 2;

FIG. 4 is a perspective view of a portion of the conveyance apparatus of the glass substrate processing station of FIGS. 2 and 3 according to an embodiment;

FIG. 5 is a perspective view of a portion of the conveyance portion of the glass substrate processing station of FIGS. 2 and 3 according to another embodiment;

FIG. 6 is a perspective view of the conveyance portion of a glass substrate processing station that may be used with the glass making apparatus of FIG. 1 illustrating the sensor controls;

FIG. 7 is a schematic illustration of the arrangement of components for a glass substrate cleaning station comprising the glass substrate processing station according to embodiments disclosed herein;

FIG. 8 is a cross sectional view of an exemplary shroud assembly according to embodiments disclosed herein;

FIG. 9A is a perspective view of an alternative shroud according to embodiments disclosed herein;

FIG. 9B is a perspective view of another alternative shroud according to embodiments disclosed herein;

FIG. 10 is a bottom view of an exemplary nozzle member;

FIG. 11A is a cross sectional view of an exemplary shroud assembly according to embodiments disclosed herein and illustrating gas flows within the shroud assembly;

FIG. 11B is a schematic illustration of gas flow from a vent of the nozzle member shown in FIG. 10 and showing an angled flow;

FIG. 11C is a schematic illustration of gas flow from a vent of the nozzle member shown in FIG. 10 showing an angled and skewed gas flow;

FIG. 12A-12D are schematic illustrations of the progression of a glass substrate past an exemplary glass substrate cleaning apparatus; and

FIG. 13 is a cross sectional view of a pair of shroud assemblies arranged in an opposing relationship on opposite sides of a glass substrate conveyed between the pair of shroud assemblies.

### DETAILED DESCRIPTION

Reference will now be made in detail to the selected embodiments of the present disclosure, examples of which are illustrated in the accompanying drawings. Whenever possible, the same reference numerals will be used throughout the drawings to refer to the same or like parts.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment.

Directional terms as used herein—for example up, down, right, left, front, back, top, bottom—are made only with reference to the figures as drawn and are not intended to imply absolute orientation unless otherwise stated.

Unless otherwise expressly stated, it is in no way intended that any method set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

While the following disclosure is presented in the context of removing particulate, for example glass particulate, from the surfaces of a glass substrate, for example an individual sheet of glass comprising two opposing major surfaces, it should be understood that the teachings of the present disclosure can be applied to the cleaning of other substrates, for example ceramic substrates, glass-ceramic substrates, ceramic substrates, polymer substrates, and the like.

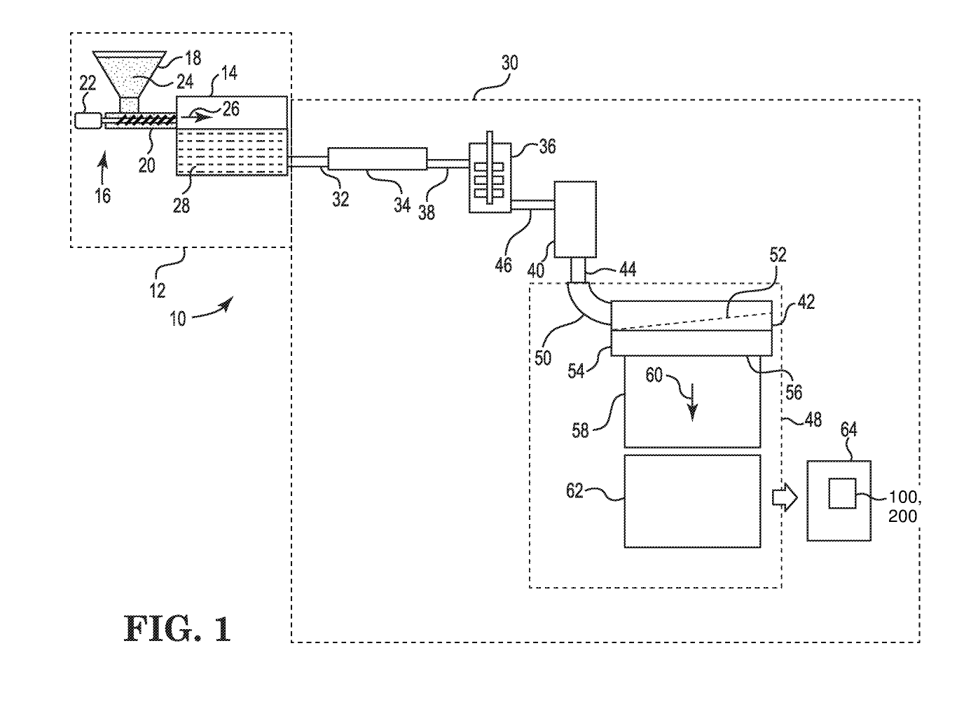

Shown in FIG. 1 is an example glass manufacturing apparatus 10. In some embodiments, the glass manufacturing apparatus 10 can comprise a glass melting furnace 12 that can further include a melting vessel 14. In addition to melting vessel 14, glass melting furnace 12 can optionally include one or more additional components such as heating elements (e.g., combustion burners or electrodes) configured to heat raw materials within the melting vessel and convert the raw materials into molten glass. In further examples, glass melting furnace 12 may include thermal management devices (e.g., insulation components) arranged to reduce heat lost from a vicinity of the melting vessel. In still further examples, glass melting furnace 12 may include electronic devices and/or electromechanical devices configured to facilitate melting the raw materials into a glass melt. Still further, glass melting furnace 12 may include support structures (e.g., support chassis, support member, etc.) or other components.

Glass melting vessel 14 is typically comprised of refractory material, such as a refractory ceramic material, for example a refractory ceramic material comprising alumina or zirconia. In some examples, glass melting vessel 14 may be constructed from refractory ceramic bricks.

In some examples, the glass melting furnace may be incorporated as a component of a glass manufacturing apparatus configured to fabricate a glass substrate, for example a glass ribbon of indeterminate length. In some examples, the glass melting furnace may be incorporated as a component of a glass manufacturing apparatus comprising a float bath apparatus, a down-draw apparatus (e.g., a fusion apparatus or a slot draw apparatus), an up-draw apparatus, a press-rolling apparatus, a tube drawing apparatus or any other glass manufacturing apparatus that would benefit from the embodiments disclosed herein. By way of example, FIG. 1 schematically illustrates glass melting furnace 12 as a component of a fusion down-draw glass manufacturing apparatus 10 for fusion drawing a glass ribbon. The glass ribbon can be wound into rolls, for example by winding the glass ribbon onto spools, or the glass ribbon can be processed into individual glass sheets by cutting the glass ribbon.

The glass manufacturing apparatus 10 (e.g., fusion down-draw apparatus 10) can optionally include an upstream glass manufacturing apparatus 16 positioned upstream of glass melting vessel 14 relative to a flow direction of molten glass. In some examples, a portion of, or the entire upstream glass manufacturing apparatus 16, may be incorporated as part of the glass melting furnace 12.

As shown in the illustrated example of FIG. 1, upstream glass manufacturing apparatus 16 can include a raw material storage bin 18, a raw material delivery device 20 and a motor 22 connected to the raw material delivery device. Storage bin 18 may store a quantity of raw material 24 that can be fed into melting vessel 14 of glass melting furnace 12, as indicated by arrow 26. Raw material 24 typically comprises one or more glass forming metal oxides and one or more modifying agents. Raw material 24 may further comprise other additives, such as fining agents, and may further include scrap glass (i.e., cullet). In some examples, raw material delivery device 20 can be powered by motor 22 such that raw material delivery device 20 delivers a predetermined amount of raw material 24 from storage bin 18 to melting vessel 14. In further examples, motor 22 can power raw material delivery device 20 to introduce raw material 24 at a controlled rate based on a level of molten glass sensed downstream from melting vessel 14. Raw material 24 within melting vessel 14 can thereafter be heated to form molten glass 28.

Glass manufacturing apparatus 10 can also optionally include a downstream glass manufacturing apparatus 30 positioned downstream of glass melting furnace 12. In some examples, a portion of downstream glass manufacturing apparatus 30 may be incorporated as part of glass melting furnace 12. For example, in some embodiments, first connecting conduit 32 discussed below, or other portions of the downstream glass manufacturing apparatus 30, may be incorporated as part of the glass melting furnace 12. Elements of downstream glass manufacturing apparatus 30, including first connecting conduit 32, may be formed from a precious metal. Suitable precious metals can include platinum group metals selected from the group of metals consisting of platinum, iridium, rhodium, osmium, ruthenium, palladium and alloys thereof. For example, downstream components of the glass manufacturing apparatus may be formed from a platinum-rhodium alloy including from about 70% to about 90% by weight platinum and about 10% to about 30% by weight rhodium. However, other suitable metals can include molybdenum, rhenium, tantalum, titanium, tungsten and alloys thereof.

Downstream glass manufacturing apparatus 30 can include a first conditioning (i.e., processing) vessel, such as fining vessel 34, located downstream from melting vessel 14 and coupled to melting vessel 14 by way of the above-referenced first connecting conduit 32. In some examples, molten glass 28 may be gravity fed from melting vessel 14 to fining vessel 34 by way of first connecting conduit 32. For instance, gravity may drive molten glass 28 through an interior pathway of first connecting conduit 32 from melting vessel 14 to fining vessel 34. It should be understood, however, that other conditioning vessels may be positioned downstream of melting vessel 14, for example between melting vessel 14 and fining vessel 34. In some embodiments, a conditioning vessel may be employed between the melting vessel and the fining vessel wherein molten glass from a primary melting vessel is further heated to continue the melting process, or cooled to a temperature lower than the temperature of the molten glass in melting vessel 14 before entering fining vessel 34.

Bubbles may be removed from molten glass 28 within fining vessel 34 by various techniques. For example, raw material 24 may include multivalent compounds (i.e. fining agents) such as tin oxide that, when heated, undergo a chemical reduction reaction and release oxygen. Other suitable fining agents include without limitation arsenic, antimony, iron and cerium. The molten glass in fining vessel 34 is heated to a temperature greater than the temperature of the molten glass in melting vessel 14, thereby heating the one or more fining agents. Oxygen bubbles produced by the temperature-induced chemical reduction of the fining agent(s) rise through the molten glass within fining vessel 34, wherein gases in the molten glass produced in melting vessel 14 can coalesce or diffuse into the oxygen bubbles produced by the fining agent. The enlarged gas bubbles can then rise to a free surface of the molten glass in the fining vessel and thereafter be vented from the fining vessel. The oxygen bubbles can further produce mechanical mixing of the molten glass in the fining vessel as the bubbles rise through the molten glass.

Downstream glass manufacturing apparatus 30 can further include another conditioning vessel that may be located downstream from the fining vessel 34, such as mixing apparatus 36 for mixing the molten glass. Mixing apparatus 36 can be used to provide a homogenous molten glass composition, thereby reducing chemical or thermal inhomogeneities that may otherwise exist within the fined molten glass exiting fining vessel 34. As shown, fining vessel 34 may be coupled to molten glass mixing apparatus 36 by way of a second connecting conduit 38. In some examples, molten glass 28 may be gravity fed from fining vessel 34 to mixing apparatus 36 by way of second connecting conduit 38. For instance, gravity may drive molten glass 28 through an interior pathway of second connecting conduit 38 from fining vessel 34 to mixing apparatus 36. It should be noted that while mixing apparatus 36 is shown downstream of fining vessel 34, mixing apparatus 36 may be positioned upstream from fining vessel 34. In some embodiments, downstream glass manufacturing apparatus 30 may include multiple mixing apparatus, for example a mixing apparatus upstream from fining vessel 34 and a mixing apparatus downstream from fining vessel 34. These multiple mixing apparatus may be of the same design, or they may be of different designs.

Downstream glass manufacturing apparatus 30 can further include another conditioning vessel such as delivery vessel 40 that may be located downstream from mixing apparatus 36. Delivery vessel 40 may condition molten glass 28 to be fed into a downstream forming device. For instance, delivery vessel 40 can act as an accumulator and/or flow controller to adjust and provide a consistent flow of molten glass 28 to forming body 42 by way of exit conduit 44. As shown, mixing apparatus 36 may be coupled to delivery vessel 40 by way of third connecting conduit 46. In some examples, molten glass 28 may be gravity fed from mixing apparatus 36 to delivery vessel 40 by way of third connecting conduit 46. For instance, gravity may drive molten glass 28 through an interior pathway of third connecting conduit 46 from mixing apparatus 36 to delivery vessel 40.

Downstream glass manufacturing apparatus 30 can further include forming apparatus 48 comprising the above-referenced forming body 42 and including inlet conduit 50. Exit conduit 44 can be positioned to deliver molten glass 28 from delivery vessel 40 to forming body 42 through inlet conduit 50. Forming body 42 can comprise a trough 52 positioned in an upper surface of the forming body and configured to receive molten glass from inlet conduit 50, and a pair of converging forming surfaces 54 that converge in a draw direction along a bottom edge 56 of the forming body. Molten glass delivered to the forming body trough via delivery vessel 40, exit conduit 44 and inlet conduit 50 overflows the walls of the trough and descends along the converging forming surfaces 54 as separate flows of molten glass. The separate flows of molten glass join below and along the bottom edge 56 to produce a single ribbon of glass 58 that is drawn in a draw direction 60 from bottom edge 56 by applying tension to the glass ribbon, such as by gravity, edge rolls and pulling rolls (not shown), to control the dimensions of the glass ribbon as the glass cools and a viscosity of the glass increases. Accordingly, as glass ribbon 58 cools, the glass goes through a visco-elastic transition and acquires mechanical properties that give the glass ribbon 58 stable dimensional characteristics. Glass ribbon 58 may, in some embodiments, be separated into individual glass substrates 62 by a glass separation apparatus (not shown) in an elastic region of the glass ribbon by either mechanical and/or laser scoring and cutting techniques. These individual glass substrates may then be transported to a subsequent downstream apparatus such as an edge trimming apparatus and/or, as described in more detail herein below, an apparatus for removal of glass particulate and other debris that may have accumulated on surfaces of the glass sheet. For example, in some embodiments a glass substrate 62 may be transported from forming apparatus 48 with a conveyance apparatus that carries the glass substrate in a vertical orientation using a gripping mechanism that holds the top edge of the glass substrate, with the glass substrate hanging downward in a nominally vertical orientation from the gripping mechanism during transport. The glass substrate may then be guided to subsequent downstream processing equipment.

Efficiency gains in the display glass industry have relied in part on faster processing speeds, desirably with improved glass output and without a degradation in quality or an increase in capital expenditure, for example by using higher melting flow rates. Combining increased flow of molten glass with thinner glass sheets means more glass sheets per unit time, which in turn requires glass sheet conveyance speeds to increase. An increase in conveyance speed, coupled with thinner glass, can cause more sway of the glass substrate when using only top edge constraint during transport of the substrate. Increased sway of the glass substrate makes guidance of the glass substrate into downstream process equipment using fixed guidance devices more difficult and increases the risk of damage to the glass substrate. As used herein, sway refers to the side-to-side swinging in a direction generally orthogonal to the major surfaces of the glass substrate (e.g., rotation about the constrained edge of the glass substrate).

When a glass substrate comes into contact with fixed position guides employed to guide an otherwise unconstrained bottom edge portion of the vertically hanging glass substrate, damage to the glass substrate is possible, for example chipping of the leading edge of the glass substrate. Other damage, such as chips or scratches on one or both major surfaces of the glass substrate due to relative motion between the fixed guide and the moving glass substrate may also occur.

In addition to a trend toward thinner glass substrates that are more susceptible to buckling, thin glass substrates are even more susceptible to impact damage when the edges are “as-cut”, e.g., glass substrate edges after cutting that have not had the benefit of a grinding or polishing (e.g., beveling or rounding) process step that may reduce or remove flaws from the substrate edges and edge surfaces and thereby improve edge strength. Individual glass substrates are typically rectangular in shape, and the unprocessed cut edges, particularly corners, are more susceptible to damage, e.g., scratching, chipping and breaking, if impacted. In the display industry, there is also a trend toward the production of display panels that exhibit greater resolution, i.e., smaller pixel sizes and/or pixel density, thereby requiring glass surface cleanliness to be even better than prior requirements. Fixed guides can cause scratches and/or chips that lead to glass particles that can adhere to the glass substrate major surfaces. These adhered glass particles can cause defects in the final display panel. Accordingly, apparatus and methods that can reduce glass particle generation within glass substrate manufacturing processes are highly desirable. Thus, using a glass substrate guidance system that does not contact the as-cut leading edge (e.g., corner) can reduce the damage, and thus particle generation, potential.

Described herein are apparatus and methods that can facilitate increased transport speeds for glass substrates while providing a natural progression from a vertical forming process, for example a fusion down draw process, into downstream processing equipment, although it should be understood that the apparatus and methods described herein may be beneficial to other glass forming processes as well, including but not limited to slot draw, rolling, and float methods of forming glass sheets. Apparatus and methods disclosed herein may also be used to decrease, such as eliminate, the amount of particulate adhering to the glass substrate.

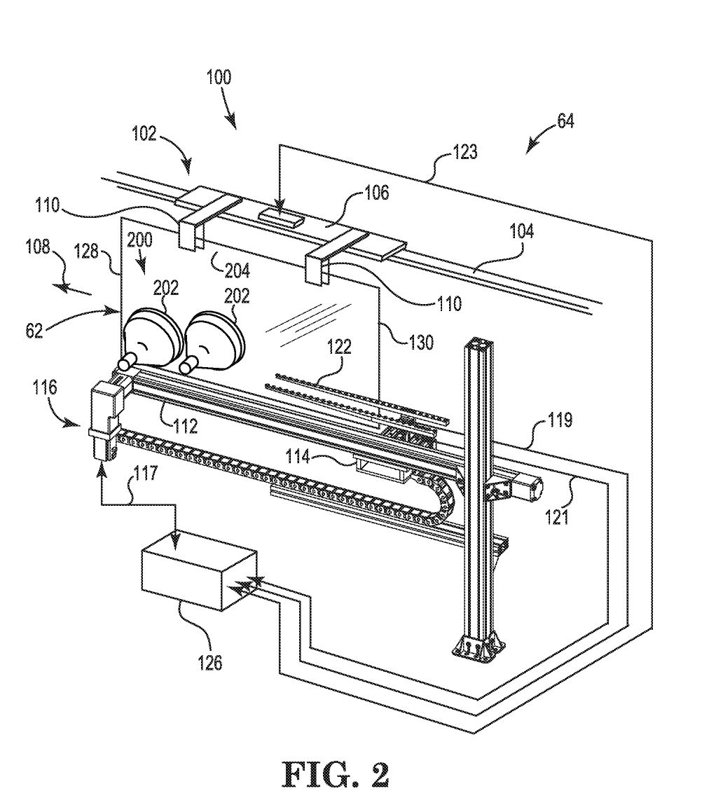

Accordingly, downstream glass manufacturing apparatus 30 may further comprise glass substrate cleaning process station 64. FIG. 2 illustrates an exemplary glass substrate cleaning process station 64 comprising conveyance apparatus 100 including a transport assembly 102 that moves glass substrates from one processing station to another processing station, for example from forming apparatus 48 to glass substrate cleaning process station 64. Transport assembly 102 may comprise a rail or track 104, for example an overhead rail system, and a movable mount assembly 106, wherein movable mount assembly 106 is configured to travel along rail 104 in conveyance direction 108. Mount assembly 106 may comprise clamping devices 110 that attach, for example clamp, to glass substrate 62, wherein mount assembly 106 may transport glass substrate 62 to a downstream destination, for example a downstream glass processing station such as glass substrate cleaning process station 64. Mount assembly 106 may be driven by any suitable means, including linear motors, chain or pulley (belt) drives, and the like. Movement of mount assembly 106 may be controlled by a controller, described more fully below. Mount assembly 106 may be moved at a constant speed, or mount assembly 106 may be moved at a variable speed. For example, in some embodiments it may be necessary to slow or stop mount assembly 106, and therefore the glass substrate being transported, so that processing of the glass substrate 62 at a downstream glass processing station, for example cleaning process station 64, may be accomplished, although in other embodiments, mount assembly 106 may be moved continuously along rail 104.

Conveyance apparatus 100 may further comprise a conveyance member 112 including a carriage assembly 114 movable along a length of conveyance member 112 in conveyance direction 108. For example, carriage assembly 114 may be coupled to a drive assembly 116 comprising, for example, a linear motor, a servo motor or other conveyance device suitable to convey carriage assembly 114 along a length of conveyance member 112 in conveyance direction 108 and in a return direction opposite conveyance direction 108. Conveyance member 112 may comprise, for example, a track, a rail or any other suitable guidance mechanism capable of supporting and guiding movement of carriage assembly 114 in the conveyance and return directions.

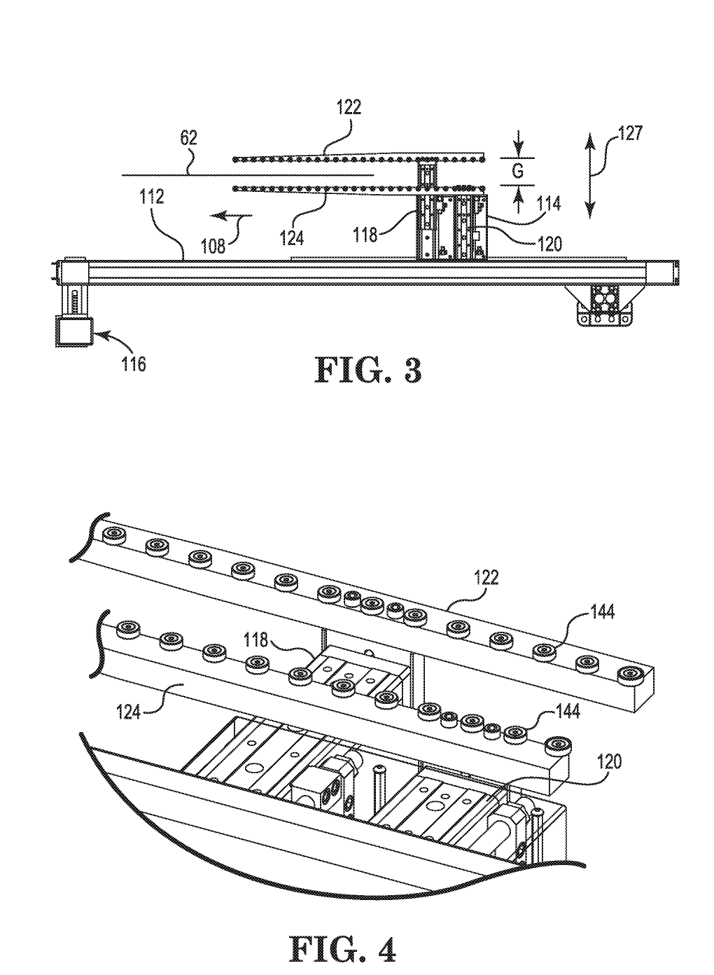

Referring now to FIGS. 3 and 4, in exemplary embodiments carriage assembly 114 may comprise first extension device 118 and second extension device 120 attached thereto, first extension device 118 and second extension device 120 comprising a first guide arm 122 and a second guide arm 124, respectively, extending therefrom and arranged in an opposing relationship with the other guide arm, for example in a direction substantially parallel with conveyance direction 108. In some embodiments, extension devices 118, 120 can be pneumatic slides that extend along lateral direction 127 orthogonal to conveyance direction 108, either toward or away from support member 112. In further embodiments, first and second extension devices 118, 120 may comprise servo motors. In the embodiment depicted in FIGS. 3 and 4, first extension device 118 is positioned such that when first extension device 118 extends, first guide arm 122 (which is the “outside” guide arm relative to support member 112 in FIGS. 3 and 4) is moved away from support member 112, and when first extension device 118 retracts, first guide arm 122 moves toward support member 112. Similarly, second extension device 120 is positioned such that when the second extension device 120 extends, second guide arm 124 (which is the “inside” guide arm relative to support member 112 in FIGS. 3 and 4) is moved away from support member 112, and when second extension device 120 retracts, second guide arm 124 moves toward support member 112. First and second extension devices 118, 120 can be used in opposition to each other such that when one extension device extends, the other extension device retracts, therefore causing first and second guide arms to perform together an opening or closing operation. For example, if first extension device 118 extends and second extension device 120 retracts, guide arms 122, 124 will perform an opening operation. Conversely, if first extension device 118 retracts and second extension device 120 extends, guide arms 122, 124 will perform a closing operation.

Conveyance apparatus 100 may further comprise controller 126 (see, for example, FIG. 2) that controls and coordinates movement of carriage assembly 114 and guide arms 122, 124 by controlling drive assembly 116 through control line 117 and extension devices 118, 120 through control lines 119, 121, respectively. Controller 126 may further control the movement of mount assembly 106 such as through control line 123, although in further embodiments mount assembly 106 may be controlled by a second controller. As used herein, the term “controller” or “processor” can encompass all apparatus, devices, and machines for processing data, including by way of embodiment a programmable processor, a computer, or multiple processors or computers. The processor can include, in addition to hardware, code that creates an execution environment for the computer program in question, e.g., code that constitutes processor firmware, a protocol stack, a database management system, an operating system, or a combination of one or more of them.

Embodiments and the functional operations described herein can be implemented in digital electronic circuitry, or in computer software, firmware, or hardware, including the structures disclosed in this specification and their structural equivalents, or in combinations of one or more of them. Embodiments described herein can incorporate one or more computer program products, i.e., one or more modules of computer program instructions encoded on a tangible program carrier for execution by, or to control the operation of, data processing apparatus. The tangible program carrier can be a computer readable medium. The computer readable medium can be a machine-readable storage device, a machine readable storage substrate, a memory device, or a combination of one or more of them.

A computer program (also known as a program, software, software application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes described herein can be performed using one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit) to name a few.

Processors suitable for the execution of a computer program include, by way of embodiment, both general and special purpose microprocessors, and any one or more processors of any kind of digital computer. Generally, a processor will receive instructions and data from a read only memory or a random access memory or both. The essential elements of a computer are a processor for performing instructions and one or more data memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices.

Computer readable media suitable for storing computer program instructions and data include all forms of data memory including nonvolatile memory, media and memory devices, including by way of embodiment semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments described herein can be implemented on a computer comprising a display device, e.g., an LCD (liquid crystal display) monitor, and the like for displaying information to the user and a keyboard and a pointing device, e.g., a mouse or a trackball, or a touch screen by which the user can provide input to the computer. Other devices can be used to provide for interaction with a user as well; for example, input from the user can be received in any form, including acoustic, speech, or tactile input.

Embodiments described herein can include a computing system that includes a back end component, e.g., as a data server, or that includes a middleware component, e.g., an application server, or that includes a front end component, e.g., a client computer having a graphical user interface or a Web browser through which a user can interact with an implementation of the subject matter described herein, or any combination of one or more such back end, middleware, or front end components. The components of the system can be interconnected by any form or medium of digital data communication, e.g., a communication network. Embodiments of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other

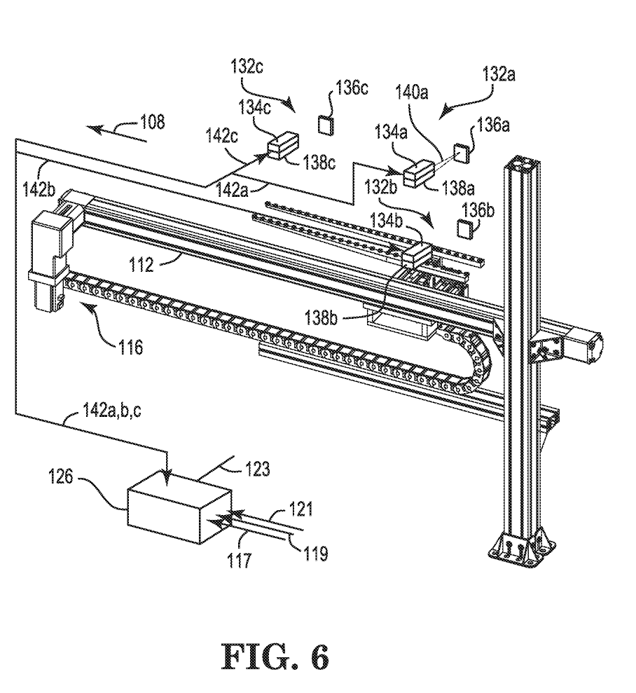

Accordingly, controller 126 may control movement of carriage assembly 114 and extension devices 118, 120 via pre-programmed instructions contained in or on computer readable media and executed by the controller, e.g., a processor. In other embodiments, controller 126 may control movement of carriage assembly 114 and extension devices 118, 120 in response to external inputs, for example sensor inputs. In still other embodiments, controller 126 may control movement of carriage assembly 114 and extension devices 118, 120 in response to both pre-programmed instructions and sensor input. For example, conveyance apparatus 100 may include sensors that detect a position of glass substrate 62 or a portion thereof, including any one or all of a leading edge 128 and/or a trailing edge 130 of glass substrate 62 relative to conveyance direction 108, for example a top portion of the leading edge, a bottom portion of the leading edge, a top portion of the trailing edge and/or a bottom portion of the trailing edge. To that end, conveyance apparatus 100 may include first sensor 132a (see FIG. 6) positioned to detect leading edge 128 of glass substrate 62 relative to conveyance direction 108. First sensor 132a may be a non-contact sensor, for example an optical sensor, although in further embodiments first sensor 132a may be a contact-style sensor. First sensor 132a may include light source 134a, reflective target 136a and detector 138a. First sensor 132a can be positioned upstream of a start position for carriage assembly 114 (as discussed in more detail below), wherein light source 134a and detector 138a are positioned on one side of the glass substrate conveyance path, and reflective target 136a is positioned on the opposite side of the conveyance path such that glass substrate 62, or a portion thereof, passes between light source 134a and reflective target 136a. Light beam 140a from light source 134a is projected across the conveyance path and reflected by reflective target 136a. The reflected light is then received by detector 138a. If glass substrate 62 passes between the light source and the reflective target, light beam 140a is disrupted. The presence and/or absence of the glass substrate indicated by the disruption of light beam 140a at detector 138a is communicated to controller 126 via an appropriate signal over data line 142a, upon receipt of which controller 126 can perform pre-programmed instructions.

It should be apparent that first sensor 132a can be arranged in a different configuration. For example, detector 138a can be positioned opposite light source 134a, such that glass substrate 62 travels between light source 134a and detector 138a, thereby eliminating the need for reflective target 136a.

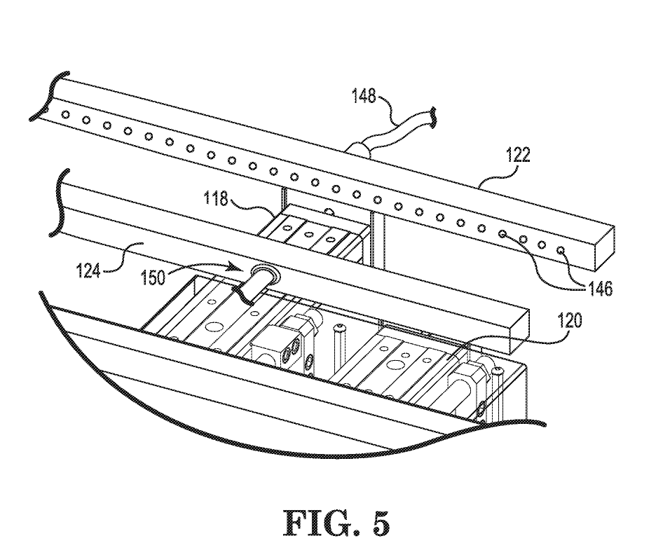

Each guide arm 122, 124 may be positioned to restrain movement of a nominally vertical glass substrate positioned between the guide arms. For example, in some embodiments, such as the embodiment depicted in FIG. 4, each guide arm 122, 124 may comprise a plurality of rollers 144 arrayed along a length of the each guide arm such that when the guide arms are moved in opposite directions along lateral direction 127 so that gap G between the guide arms is reduced, glass substrate 62 may contact the rollers. For example, depending on the width or spacing of gap G between the opposing guide members, glass substrate 62 may contact the rollers only sporadically, for example during swaying of the glass substrate, thereby limiting movement of the glass substrate bottom edge to be within gap G. In other embodiments, guide arm 122, 124 may be positioned such that they pinch the bottom edge portion of the glass substrate during the time glass substrate 62 is positioned between the guide arms and thus rollers 144 are in continuous contact with the glass substrate. In further embodiments, non-contact restraint may be employed, wherein guide arms 122, 124 may each comprise a plurality of gas vents 146 as shown in FIG. 5. A pressurized gas supplied to the guide arms via gas supply lines 148, 150 may then be forced through the gas vents 146 of the opposing guide arms, thereby restraining lateral movement of the glass substrate. In some embodiments, the pressurized gas may be air, although in further embodiments the gas may be a different gas.

Methods of operating conveyance apparatus 100 will now be discussed. Referring to FIGS. 2 and 6, in one embodiment, as transport assembly 102 moves glass substrate 62 along rail 104, light source 134a from first sensor 132a is projecting light beam 140a that reflects from reflective target 136a and is received by detector 138a, in response to which detector 138a indicates to controller 126 with a suitable electrical signal that the conveyance path is clear (i.e., there is an absence of a glass substrate). Carriage assembly 114 is in its initial start position (e.g., to the right end of support member 112 in FIGS. 2 and 6), and guide members 122, 124 are in an open position, for example wherein gap G is greater than the thickness of the glass substrate. For example, gap G in the open position may be equal to or greater than 200 millimeters, although in further embodiments, gap G may be less than 200 millimeters but still greater than the thickness of the glass substrate. As glass substrate 62 continues to move in conveyance direction 108, leading edge 128 of glass substrate 62 intersects light beam 140a, at which point detector 138a fails to receive sufficient reflected light from reflective target 136a. Accordingly, detector 138a registers the presence of the glass substrate and sends an appropriate signal to controller 126. In response, controller 126 instructs carriage assembly 114 to begin moving in conveyance direction 108.

In some embodiments, conveyance apparatus 100 may further comprise a second sensor 132b positioned below first sensor 132a, second sensor 132b comprising similar components as first sensor 132a. For example, second sensor 132b may comprise a light source 134b, reflective target 136b and detector 138b positioned to receive a light beam (e.g., similar to light beam 140a of first sensor 132a) from light source 134b reflected from reflective target 136b. Second sensor 132b may be positioned so as to detect leading edge 128 simultaneously with first sensor 132a. That is, for a rectangular glass substrate, and assuming proper alignment of the top edge of the glass substrate in clamping devices 110, leading edge 128 should present a vertical line. Consequently leading edge 128 should “break” the light beams from both the first and second sensor assemblies 132a,132b substantially simultaneously. If controller 126 receives signals indicating that simultaneous detection (within a predetermined difference) of the leading edge was not obtained, then a possible cause could be the glass substrate is broken. The controller may then initiate additional actions, including but not limited to stopping or slowing conveyance apparatus 100 so that glass substrate 62 may be removed. Alternatively, or in addition, conveyance apparatus 100 may continue conveying glass substrate 62, but controller 126 registers the position of the glass substrate (relative to other glass substrates that may be conveyed) so that a downstream action can be taken, for example additional inspection by a human operator. If, on the other hand, simultaneous detection of the leading edge is obtained, the conveyance apparatus proceeds to move the glass substrate in the conveyance direction to a next processing station.

Detection of leading edge 128 can be used by controller 126 to begin movement of carriage assembly 114 in conveyance direction 108. In some embodiments, the speed of glass substrate 62 in the conveyance direction may be obtained by controller 126 directly from mount assembly 106. However, in other embodiments conveyance apparatus 100 may include a third sensor 132c positioned downstream from first sensor 132a. Similar to first and second sensors 132a, 132b, third sensor 132c may include light source 134c, reflective target 136c and detector 138c and may operate in the same or similar manner as first and second sensors 132a, 132b. Controller 126 can calculate the time between the “glass present” signal from first sensor 132a (and/or second sensor 132b) and the “glass present” signal from third sensor 132c and, for a given glass substrate size pre-programmed into the controller, a speed of the glass substrate in the conveyance direction can be calculated. Thus, once controller 126 has calculated the conveyance speed of the glass substrate, controller 126 can match the speed of carriage assembly 114 to the speed of glass substrate 62. Controller 126 may also signal extension devices 118, 120 to begin closing, thereby reducing or increasing gap G.

As previously noted, guide arms 122, 124 may reduce gap G without producing continuous contact with glass substrate 62, thereby forming a maximum movement envelope defined by gap G for the bottom edge of the glass substrate between portions of the guide arms. That is, gap G may be reduced to a value less than the fully open gap distance, but large enough so that the bottom edge of glass substrate is allowed some small amount of lateral movement (movement orthogonal to the conveyance direction) that has been determined not to impact the process (e.g., cause damage to the glass substrate). For example, gap G may be reduced to a gap distance in a range from about 10 mm to about 100 mm, for example in a range from about 20 mm to about 90 mm. As previously described, guide arms 122, 124 may comprise rollers 144 that provide a contact surface against which glass substrate 62 may come in contact with. Rollers 144 ensure relative motion between the glass substrate and the guide arms is accommodated by the rollers rolling against the major surfaces of the glass substrate rather than producing a sliding motion between the guide arms and the glass substrate that could mark or damage the surfaces of the glass substrate. However, in other embodiments, gap G may be reduced until guide arms 122, 124 are in continuous contact with glass substrate 62, thereby pinching glass substrate between the opposing guide arms. Whether guide arms 122, 124 are in continuous contact, or only intermittent contact, may be dictated by the nature of the downstream process. For example, continuous contact may be required for very precise positioning of the leading edge as the leading edge enters the downstream process. Moreover, continuous contact between the glass substrate bottom edge portion and the guide arms can be used to flatten the glass substrate should the glass substrate exhibit curvature (i.e., “bow”), that may prove problematic when entering the downstream process. For example, curvature may increase the likelihood of damaging contact between the leading edge of the glass substrate and downstream processing equipment.

In still other embodiments, each guide arm may be fitted with one or more endless belts (not shown), wherein the belts function in a manner similar to rollers 144.

In other embodiments, guide arms 122, 124 may use air pressure to force the glass substrate into a predetermined movement envelope between the guide arms. For example, each guide arm may include a plurality of gas vents 146 in a face of each guide arm that opposes the glass substrate. Pressurized gas can then be forced from the gas vents and directed to the major surfaces of the glass substrate. The gas pressure can be balanced between the two guide arms so that the glass substrate is positioned in a desired location between the guide arms, such as in the middle of gap G. Alternatively, or in addition, the faces of the guide arms opposed to the glass substrate major surfaces may comprise a porous material including a multitude of passages, for example graphite, densely perforated polymer or metal, or any other micro-porous material suitable for emitting a gas at glass substrate 62 and maintaining a position of glass substrate 62 within gap G.

It should be understood that since leading edge 128 may be more vulnerable to damage from contact than other portions of the glass substrate, it is desirable that guide arms 122, 124 do not contact the glass substrate at leading edge 128. Thus, controller 126 may be programmed such that the extreme downstream ends of the guide arms (leading tips of the guide arms) are positioned upstream from the leading edge relative to conveyance direction 108 when the guide arms have reached a final guiding position (e.g., when gap G is set at a predetermined value and no longer being reduced). That is, the ends of the guide arm should be positioned back from the leading edge relative to conveyance direction 108. For example, controller 126 can be programed to drive carriage assembly 114 to position guide arms 122, 124 such that the leading tips of the guide arms are behind the leading edge relative to conveyance direction 108 by at least 10 mm, for example in a range from about 10 mm to about 100 mm, for example in a range from about 10 mm to about 60 mm, including all ranges and subranges therebetween.

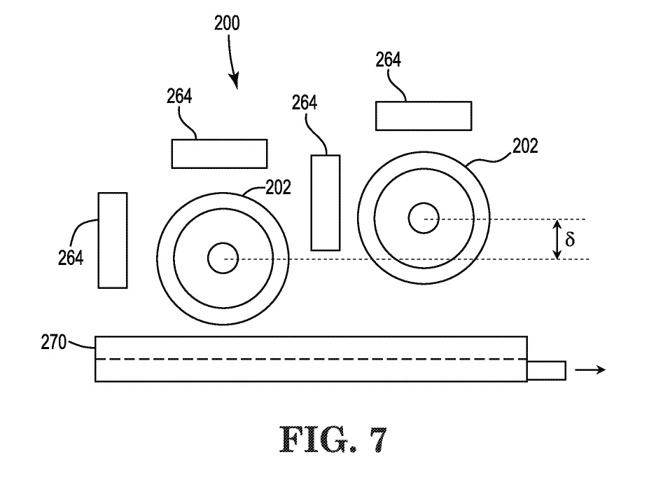

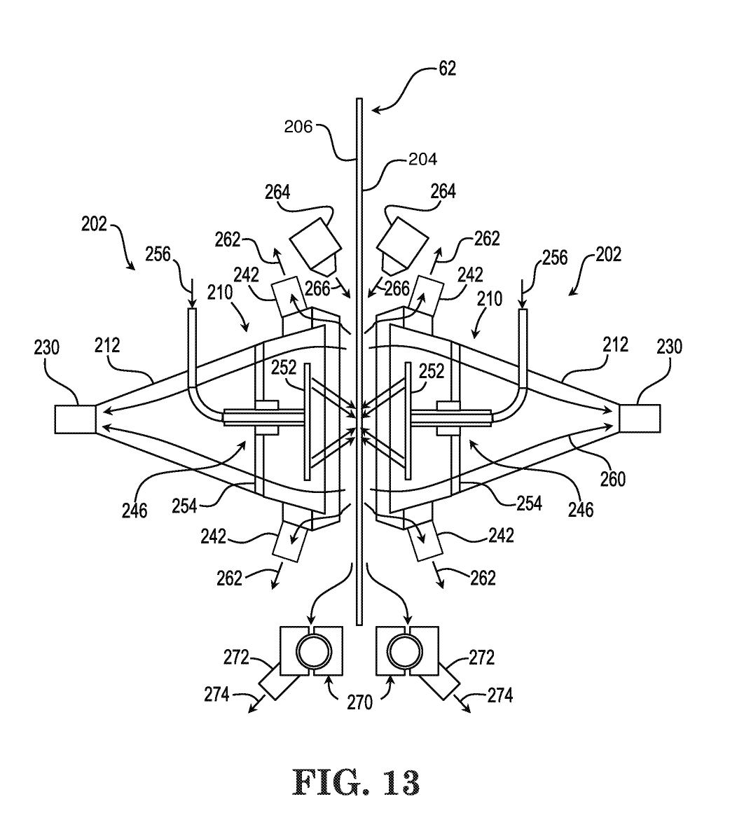

Returning to FIGS. 1 and 2, glass substrate cleaning process station 64 may further comprise glass cleaning apparatus 200. Glass cleaning apparatus 200 comprises shroud assembly 202 arranged such that the shroud assembly is positioned proximate a first major surface 204 of glass substrate 62 as the glass substrate is conveyed by conveyance apparatus 100. For example, in the embodiment illustrated in FIG. 2, glass substrate 62 is conveyed in a vertical orientation supported by a top of the glass substrate and guided at a bottom thereof by guide arms 122, 124, and a shroud assembly 202 is positioned adjacent first major surface 204 of glass substrate 62. In some embodiments, glass cleaning apparatus 200 may include a plurality of shroud assemblies 202. For example, in the embodiment illustrated in FIG. 2, at least two shroud assemblies 202 are shown, both of the at least two shroud assemblies arranged along and adjacent to the same major surface of glass substrate 62, e.g., first major surface 204, as the glass substrate is conveyed in conveyance direction 108. However, in further embodiments, the at least two shroud assemblies 202 may be adjacent opposite major surfaces of the glass substrate, for example directly opposite each other to form a pair of opposing shroud assemblies 202 on opposite sides of glass substrate 62 as glass substrate 62 is conveyed along conveyance direction 108 (see, for example, FIG. 13). In still further embodiments, multiple pairs of opposing shroud assemblies may be utilized. For example, two shroud assemblies arranged adjacent first major surface 204 of the glass substrate and another pair of shroud assemblies arranged adjacent the opposite second major surface 206 of the glass substrate and aligned (directly opposite) with the first pair of shroud assemblies. Multiple shroud assemblies positioned adjacent one major surface of the glass substrate as the glass substrate is conveyed along conveyance direction 108 need not be arranged at a same vertical height along the glass substrate. For example, FIG. 7 illustrates two shroud assemblies 202 as seen from the side displaced vertically from each other by a distance 8 as measured from a center of each shroud. In still further embodiments, multiple shroud assemblies may be arranged such that an entire major surface (or both major surfaces) can be swept by the shroud assemblies as the glass substrate is transported past the shroud assembly.

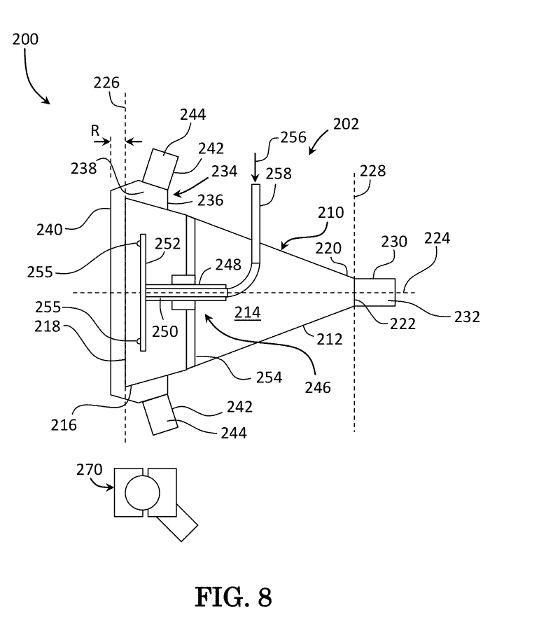

Turning now to FIG. 8, shroud assembly 202 comprises a shroud 210. Shroud 210 may, in some embodiments, comprise a generally conically shaped hollow body, hereinafter funnel 212, defining an interior volume 214. Funnel 212 includes a first end 216 defining a first circular opening 218, and a second end 220 opposite first end 216 and defining a second circular opening 222, second opening 222 comprising a diameter smaller than a diameter of first opening 218. Although not required, first and second openings 218 and 222 may be aligned such that a projection of second opening 222 on first opening 218 may be concentric with first opening 218. That is, longitudinal axis 224 may extend through the center of both first and second openings 218, 222. For example, both first opening 218 and second opening 222 may be concentric with longitudinal axis 224, which is a longitudinal axis of funnel 212. Although additionally not required, a first plane 226 in which first opening 218 entirely lies may be parallel with a plane 228 in which second opening 222 entirely lies. Accordingly, longitudinal axis 224 may be orthogonal to both plane 226 and plane 228.

Shroud 210 may, in some embodiments, further comprise a hollow neck portion 230 attached to funnel 212 at second end 220, hollow neck portion 230 extending outward from funnel 212, wherein neck portion 230 forms a passage 232 in fluid communication with the hollow interior 214 of funnel 212. Neck portion 230 may be, for example, a generally cylindrical tube or pipe extending away from second end 220, and may be concentric with longitudinal axis 224.

Shroud 210 may, in some embodiments, also comprise skirt portion 234 including flange 236, skirt portion 234 comprising an additional shroud member extending around and spaced apart from first end 216 of funnel 212 and connected to funnel 212 by flange 236, wherein skirt portion 234 defines an annular interior space 238 between funnel 212 and skirt portion 234 and a third opening 240 extending around first end 216. Skirt portion 234 may also include at least one hollow exhaust tube 242 attached thereto and defining a passage 244 extending therethrough, the at least one exhaust tube in fluid communication with interior space 238 through passage 244, although in further embodiments, skirt portion 234 may include multiple exhaust tubes, each exhaust tube similarly in fluid communication with interior space 238 through a passage 244. Skirt portion 234 may extend beyond first end 216 of funnel 212 in a direction parallel with longitudinal axis 224, for example by a distance R.

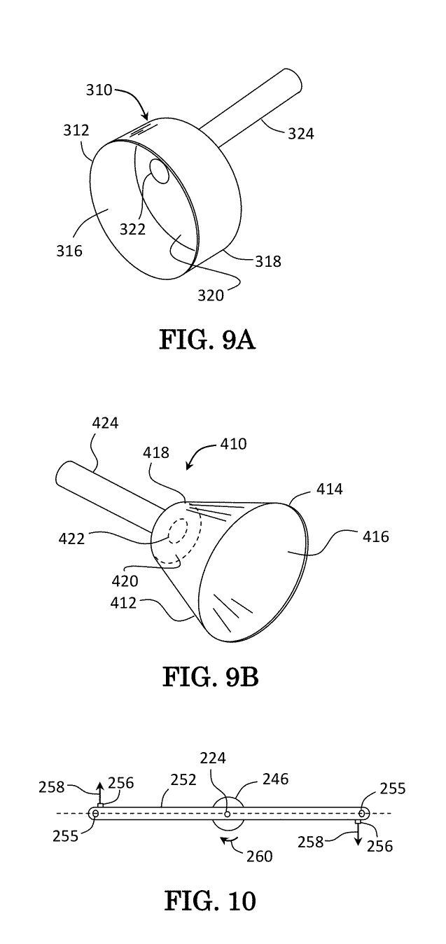

Alternatively, shroud assembly 202 may comprise a shroud 310 as depicted in FIG. 9A. Shroud 310 may comprise a generally cylindrical hollow body including a first end 312 defining first opening 316, and a substantially closed second end 318, where second end 318 may be closed, for example with a planar or dome-shaped end member 320 comprising a small (relative to first opening 316) second opening 322. That is, a diameter of second opening 322 may be less than a diameter of first opening 316. Shroud 310 may further comprise a hollow neck portion 324 attached to end member 320 at second opening 322 and extending outward from end member 320, wherein neck portion 324 forms a passage in fluid communication with the hollow interior of shroud 310. Neck portion 324 may be, for example, a generally cylindrical tube or pipe extending away from end member 320. In some embodiments, a projection of second opening 322 on a plane in which first opening 316 entirely lies may be concentric with first opening 316, although in further embodiments, a projection of second opening 322 on the plane may be laterally offset from first opening 316.

In still other embodiments, shown in FIG. 9B, a shroud 410 may be a conical body similar to funnel 212 illustrated in FIG. 8, comprising a first end 414 defining a first opening 416, and a second end 418 substantially closed by an end member 420, for example a planar or dome-shaped member. End member 420 may define a second opening 422 with a diameter less than a diameter of first opening 416. As in the embodiment of FIG. 9A, shroud 410 may further include a hollow neck portion 424 attached to end member 420 and extending outward therefrom, wherein neck portion 424 forms a passage in fluid communication with the hollow interior of shroud 410. Neck portion 424 may be, for example, a generally cylindrical tube or pipe extending away from end member 420. A projection of second opening 422 on a plane in which first opening 416 entirely lies is concentric with first opening 416. For the purpose of description and not limitation, the following disclosure is presented in the context of a funnel-shaped shroud 212 as illustrated in FIG. 8.

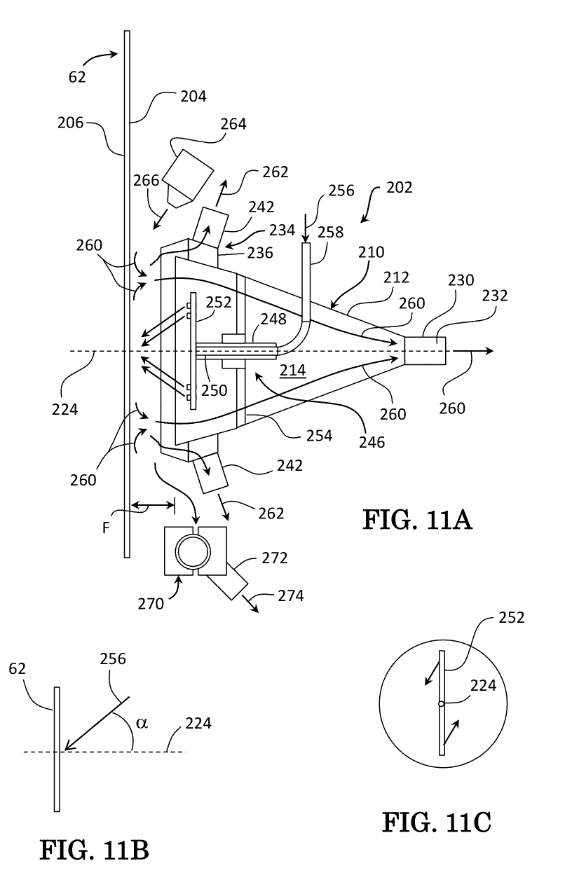

Referring back to FIG. 8, shroud assembly 202 may further comprise a gas delivery device 246 positioned within interior volume 214. For example, gas delivery device 246 may comprise a central shaft 248 including a gas delivery passage 250 and a nozzle member 252 rotatably coupled to central shaft 248. Nozzle member 252 may be bar shaped, as shown, including two arms extending outward from the center of rotation, which coincides with longitudinal axis 224, or nozzle member 252 may comprise more than two arms. In some embodiments, nozzle member 252 may comprise a disk, or any other shaped member capable of rotational motion about an axis of rotation. Gas delivery device 246 may be attached to and supported within interior volume 214 by support member 254 that is connected with an interior surface of funnel 212. In some embodiments, nozzle member 252 may be directly and rotatably coupled to support member 254. In some embodiments, central shaft 248 may be rigidly coupled to nozzle member 252, wherein shaft member 252 is rotatably coupled to support member 252. Gas delivery passage 250 is in fluid communication with a source (not shown) of pressurized gas 256 such that pressurized gas 256 is directed to nozzle member 252 through gas supply line 258 and gas delivery passage 250. Gas delivery device 246 may include gas passages and a plurality of vents 254 positioned in nozzle member 252 such that when gas delivery device 246 is supplied with a pressurized gas, such as pressurized air, the gas issues from the vents 254 in nozzle member 252 in a direction toward glass substrate 62. For example, in the embodiment illustrated in FIG. 11B, vents 254 can be arranged such that gas 256 exits vents 254 at a predetermined angle relative to axis 224. For example, gas 256 may issue from vent 254 at an angle α of approximately 0 degrees relative to axis 224 (i.e., perpendicular to surface 204 of glass substrate 62) or at any angle in a range from greater than zero degrees to about 60 degrees relative to axis 224. In some embodiments, the gas may issue in an inward direction, toward axis 224, although not necessarily in a direction intersecting axis 224. For example, in some embodiments the gas may issue inward, but in a direction skewed from axis 224 (see FIG. 11C). In some embodiments, gas delivery device 246 may comprise a plurality of vents configured to direct a flow of gas in a direction toward the glass substrate. For example, nozzle member 252 may include multiple vents 254 located at opposite ends of the nozzle member and arranged to direct a flow of gas generally at glass substrate 62, either perpendicular to a major surface of the glass substrate, or at an angle to the major surface.

Referring to FIG. 10, nozzle member 252 may further comprise a second plurality of vents 256 positioned such that gas exits the nozzle member in a direction substantially parallel with the glass substrate, as indicated by arrows 258, thereby providing thrust that propels the rotatable nozzle member in a circular direction about axis 224. Accordingly, nozzle member 252 may be rotated within interior space 214. As nozzle member 252 rotates within interior space 214, gas issuing from the first plurality of vents 254 traces out a circular pattern and is directed toward the glass substrate positioned adjacent to shroud assembly 202. In accordance with embodiments where the first plurality of vents 254 are configured to direct the flow of gas at an angle generally in a direction of axis 224, the gas flow dislodges particulate on the glass substrate and blows the particulate toward the center axis of funnel 212 and away from the edges thereof.

Referring to FIGS. 8 and 11A, neck member 230 is in fluid communication with a vacuum source (not shown) such that a flow of air 260 is drawn into funnel 212 through first opening 218, the flow of air further drawn from funnel 212 and evacuated through neck portion 230. That is, a suction is applied to interior space 214 through neck member 230. Additionally, the at least one exhaust tube 242 connected with skirt portion 234 is also in fluid communication with a vacuum source such that a flow of air 262 is drawn into the interior space 238 between skirt portion 234 and funnel 212 and is drawn from interior space 238 through exhaust tube 242.

Referring to FIGS. 7 and 11A, glass cleaning apparatus 200 may further comprise a gas knife 264 (e.g., air knife), wherein gas knife 264 is supplied with a pressurized gas, for example air, and the gas is expelled from a slot in the gas knife at high velocity, as indicated by arrow 266. The gas expelled from the gas knife is directed at a major surface of glass substrate 62 adjacent to glass cleaning apparatus 200 such that particulate that escapes from shroud assembly 202 is pushed in a direction back toward the shroud assembly and removed from the surface of the glass substrate. As shown in FIG. 11A, the gas exiting gas knife 264 is directed in a direction toward gap F between shroud 212 and first surface 204 of glass substrate 62. In some embodiments, more than one gas knife may be associated with each glass cleaning apparatus. For example, FIG. 7 illustrates at least two gas knives 264 associated with each of two shroud assemblies 202, a gas knife aligned parallel with conveyance direction 108 and a gas knife arranged orthogonal to conveyance direction 108.

Summarizing, as glass substrate 62 moves in conveyance direction 108 past glass cleaning assembly 200 guided by guide arms 122, 124, rotary nozzle 252 rotates, sweeping a circular pattern over first major surface 204. Gas exiting vents 254 in the rotary nozzle impinge on first major surface 204 of glass substrate 62 and lift particulate, such as glass debris, from the first major surface. A suction applied to interior space 238 defined between skirt portion 234 and funnel 212 captures particulate that may be blown by gas exiting vents 254 in a direction away from the interior of funnel 212 and evacuates the particulate through exhaust tube 242 so that the particulate does not re-attached on first major surface 204 outside the path of shroud assembly 202.

Additionally gas knife 264 blows debris back in a direction toward third opening 240 where the particulate may be exhausted by the suction applied through exhaust tube 242.

In some embodiments, glass cleaning apparatus 200 may further comprise a vacuum channel 270 positioned below shroud assembly 202, for example below glass substrate 62 along the conveyance path of the glass substrate bottom edge portion and extending along the conveyance path. Vacuum channel 270 may comprise one or more vacuum passages in fluid communication with a source of vacuum. Vacuum channel 270 is positioned to capture particulate that may escape shroud assembly 202 and which particulate may be drawn downward by gravity, for example large particles of sufficient weight that the gas flow through funnel 212 is insufficient to draw the particles into and out of the funnel. The particulate captured by vacuum channel 270 may then be drawn from vacuum channel 270 through passage 272, as indicated by arrow 274 (see FIG. 11A), and subsequently captured, for example, in a filter device, for example a filter bag.

Modeling of the particulate removal efficiency of shroud assembly 202 took into consideration both the particulate size and the velocity of the gas being removed from within skirt portion 234 through exhaust tube 242. It was found that for particles of about 100 micrometers in width (e.g., equivalent diameter), the particles were generally unaffected by the shroud assembly 202 and dropped downward where they could be captured by vacuum channel 270. For particles with a width of equal to or less than 60 micrometers, for example with a width equal to or less than 30 micrometers, including for example a width of 10 micrometers, a gas velocity equal to or greater than about 2 meters/second through exhaust tube 240 tended to cause the particles to bounce against the glass substrate, thereby presenting an opportunity for damage to the substrate. Accordingly, it was found that maintaining the velocity of gas through exhaust tube 242 less than 2 meters/second was capable of removing particulate less than 100 micrometers, for example equal to or less than about 60 micrometers without causing bounce-back of the particulate into the glass substrate, for example a velocity in a range from about 0.05 meters/second to less than 2 meters/second. Optimum performance was achieved at an exhaust velocity through exhaust tube 240 equal to or less than about 1 meter/second, for example in a range from about 0.05 meters/second to about 1 meter/second, for example in a range from about 0.1 meters/second to about 0.7 meters/second.

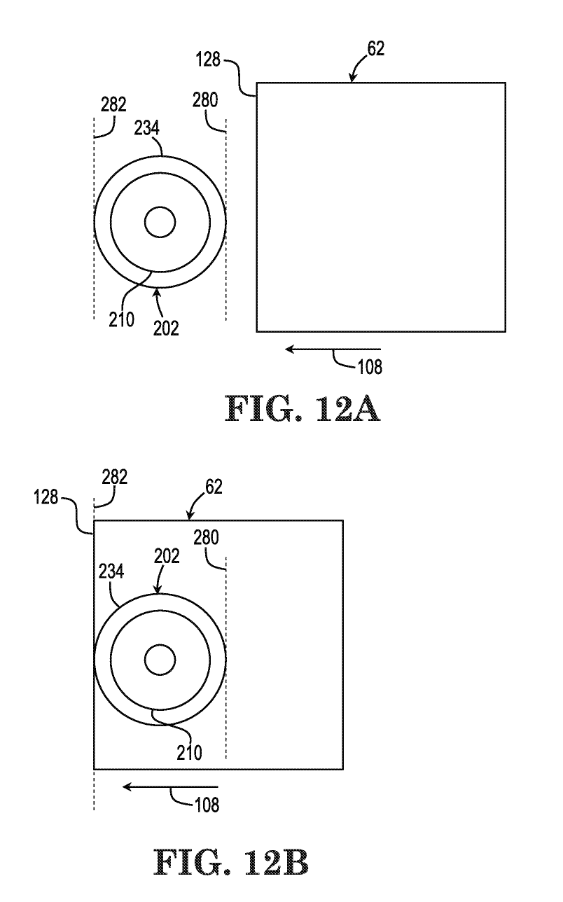

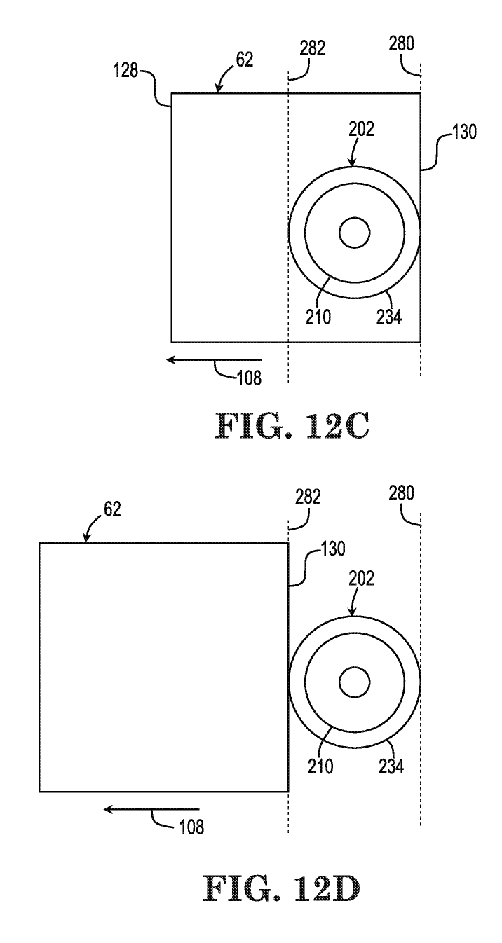

Modeling has shown that a suction applied on the interior space 214 of funnel 212 via neck member 230 (hereinafter referred to as center vacuum) is disruptive to the particulate removal function of the rotary nozzle and the suction applied at skirt portion 234 (hereinafter referred to as the ring vacuum). A preferred method of operation for glass cleaning apparatus 200 is to turn off the center vacuum while a glass substrate is adjacent funnel 212, and then utilize the center vacuum during the period when no glass substrate is adjacent the funnel to clean the interior of the funnel. This can be visualized using FIGS. 12A-12D.

Referring to FIG. 12A, dashed line 280 represents a plane tangent to a point on shroud assembly 202 nearest advancing glass substrate 62 traveling in conveyance direction 108, and in particular, nearest skirt portion 234. Tangent plane 280 is orthogonal to conveyance direction 108. Prior to leading edge 128 reaching tangent plane 280, the center vacuum may be activated so that a suction is drawn on volume 214 through neck portion 230, thereby removing particulate from funnel 212 that may have accumulated from a previous glass substrate conveyed past shroud assembly 202. When leading edge 128 reaches tangent plane 280, or at some time before leading edge 128 reaches tangent plane 280, the center vacuum is turned off so that during the time when shroud assembly 202 is directly opposing glass substrate 62 the center vacuum is inactive. In some embodiments, gas pressure to nozzle assembly 246 may be turned off prior to or at the time leading edge 128 reaches tangent plane 280, then, when leading edge 128 reaches tangent plane 282 (a plane tangent to a point on shroud assembly 202 opposite the point tangent to tangent plane 280) and shroud assembly 202 is entirely positioned adjacent glass substrate 62, as illustrated in FIG. 12B, the gas pressure to nozzle assembly 246 may be reestablished.

Referring now to FIG. 12C, as trailing edge 130 reaches tangent plane 280, gas pressure to nozzle assembly 246 may be ceased. Then, as glass substrate continues to traverse along conveyance direction 108, when trailing edge 130 reaches tangent plane 282 as shown in FIG. 12D (when shroud assembly 202 is no longer opposite glass substrate 62), or thereafter, the center vacuum may be turned on to aid in the removal of particulate that may be collected within funnel 212.

During the preceding sequence of events, the one or more gas knives 264 may be operated continuously. Similarly, during the preceding sequence of events, vacuum channel 270 may be operated continuously. In some embodiments, a suction may be applied through vacuum port 242 continuously throughout the preceding sequence, although in further embodiments, the suction through vacuum port 242 may be toggled on and off at the same time, or about the same time, pressurized gas to nozzle member 252 is toggled.

Once glass substrate 62 has been transferred to downstream process station 64, for example glass cleaning apparatus 200, and leading edge 128 has cleared damaging aspects of the downstream process equipment, controller 126 can instruct extension devices 118, 120 to open gap G between guide arms 122, 124 by extending guide arm 122 and retracting guide arm 124. Additionally, controller 126 can direct drive assembly 116 to move carriage assembly 114 in a return direction opposite conveyance direction 108 until carriage assembly 114 is returned to the start position to await the next glass substrate, whereupon the process cycle repeats.

It will be apparent to those skilled in the art that various modifications and variations can be made to embodiments of the present disclosure without departing from the spirit and scope of the disclosure. Thus it is intended that the present disclosure cover such modifications and variations provided they come within the scope of the appended claims and their equivalents.

1. An apparatus for cleaning a planar substrate comprising:
a shroud assembly, the shroud assembly comprising:
a shroud defining a first hollow interior space, the shroud including a first end defining a first opening into the first hollow interior space and a second end opposite the first end and defining a second opening into the first hollow interior space;
a nozzle member mounted within the first hollow interior space and rotatable about an axis of rotation, the nozzle member comprising a vent arranged to direct a first flow of gas toward the planar substrate;
a skirt portion positioned about at least a portion of the shroud adjacent the first end such that an annular second hollow interior space is formed between the skirt portion and the shroud; and
a neck portion in fluid communication with the first interior space through the second opening and an exhaust tube in fluid communication with the annular second interior space.

2. The apparatus according to claim 1, wherein the shroud comprises a conical portion attached to the neck portion.

3. The apparatus according to claim 1, wherein the vent is arranged to direct the first flow of gas in a direction toward the axis of rotation.

4. The apparatus according to claim 1, further comprising at least one gas knife positioned proximate the shroud assembly and arranged to direct a second flow of gas in a direction toward the planar glass substrate.

5. The apparatus according to claim 1, further comprising a vacuum channel positioned below the shroud assembly.

6. The apparatus according to claim 1, further comprising a transport assembly configured to convey the substrate in a substantially vertical orientation such that the first opening is positioned adjacent a major surface of the planar substrate.

7. The apparatus according to claim 6, wherein the apparatus comprises a pair of opposing shroud assemblies positioned such that the planar substrate is conveyed between the pair of opposing shroud assemblies.

8.-12. (canceled)

13. The apparatus according to claim 1, further comprising a conveyance apparatus, the conveyance apparatus comprising:
a conveyance member;
a carriage assembly coupled to the conveyance member and movable along a length thereof in a conveyance direction;
a pair of extension devices coupled to the carriage assembly, each extension device of the pair of extension devices including a guide arm extending therefrom in a direction substantially parallel with the conveyance direction, the guide arms movable along a lateral direction orthogonal to the conveyance direction;
a first sensor positioned to detect a leading edge of the glass sheet at a first position; and
a controller configured to control and coordinate movement of the carriage assembly and the pair of extension devices.

14. The apparatus according to claim 13, wherein each guide arm comprises a plurality of rollers arrayed along a length of the guide arm.

15. The apparatus according to claim 13, wherein each guide arm comprises a plurality of gas ports in fluid communication with a source of a pressurized gas.

16. (canceled)

17. The apparatus according to claim 13, further comprising a second sensor positioned to detect a leading edge of the glass sheet at a second position downstream of the first position relative to the conveyance direction.

18. The apparatus according to claim 17, further comprising a third sensor positioned to detect the leading edge of the glass sheet at a third position, the third sensor vertically aligned with the first sensor.

19. The apparatus according to claim 18, wherein the third sensor is positioned to detect the leading edge of the glass sheet at a bottom edge portion of the glass sheet.

20. A method of cleaning a glass substrate comprising:
conveying the glass substrate in a conveyance direction, the glass substrate passing adjacent a glass cleaning apparatus comprising a shroud assembly, the shroud assembly including:
a shroud defining a first hollow interior space, the shroud comprising a first end defining a first opening into the first hollow interior space and a second end opposite the first end, the second end defining a second opening into the first hollow interior space, a diameter of the second opening less than a diameter of the first opening;
a gas nozzle member mounted within the interior space and rotatable about an axis of rotation, the gas nozzle member comprising a vent;
a skirt portion positioned about at least a portion of the shroud adjacent the first opening such that an annular second hollow interior space is formed between the skirt portion and the shroud; and
an exhaust tube in fluid communication with the annular second hollow interior space;
directing a flow of gas through the vent, the flow of gas rotating the gas nozzle member about the axis of rotation such that the flow of gas sweeps a circular path over a surface of the glass substrate through the first opening and dislodges particles from the major surface of the glass substrate; and
applying a suction to the exhaust tube, thereby exhausting the dislodged particles through the exhaust tube.

21. (canceled)

22. The method according to claim 20, wherein a velocity of gas exhausted through the first exhaust tube is in a range from about 0.05 meters/second to about 1 meter/second.

23. The method according to claim 20, wherein a velocity of gas exhausted through the exhaust tube is in a range from about 0.1 meters/second to about 0.7 meter/second

24. The method according to claim 20, wherein the shroud comprises a second vacuum port in fluid communication with the first hollow interior space, the method further comprising applying a suction to the second vacuum port only when the glass substrate is not adjacent the shroud assembly.

25. The method according to claim 20, wherein the flow of gas through the first vent is ceased when the shroud assembly is not adjacent the glass substrate.

26. The method according to claim 20, wherein a projection of the second opening onto the first opening is concentric with the first opening.

27.-28. (canceled)

29. The method according to claim 20, wherein the conveying comprises:
sensing a position of a leading edge of the glass substrate relative to the conveyance direction;
using the sensed position of the leading edge to determine a conveyance speed;
moving a carriage assembly in the conveyance direction at the conveyance speed in response to the sensed position of the glass sheet, the carriage assembly comprising a pair of opposing guide arms coupled thereto and extending therefrom in a direction substantially parallel with the conveyance direction;
moving the guide arms in a lateral direction orthogonal to the conveyance direction from an open position to a constraining position, thereby reducing a gap between the guide arms and constraining movement of the glass substrate in a direction orthogonal to the conveyance direction.
